(19) United States
(12) Patent Application Publication
(10) Pub. No.: US 2004/0114054 A1
(43) Pub. Date: Jun. 17, 2004

(54) Method of detecting a significant change of scene

(76) Inventors: Richard Louis Mansfield, Stourport-on-Severn (GB); Nicolas John Flowers, Birmingham (GB)

Correspondence Address: Ira S Dorman, Suite 200, 330 Roberts Street, East Hartford, CT, 06108, US

(21) Appl. No.: 10/468,382

(22) PCT Filed: Feb. 21, 2002
(86) PCT No.: PCT/GB02/00762

(30) Foreign Application Priority Data
Feb. 28, 2001 (GB) 0104922.0

(51) Int. Cl. H04N 5/14

(52) U.S. Cl. 348/700

(57) ABSTRACT

A significant change of scene in a gradually changing scene is detected with the aid of at least one camera means (2) for capturing digital images of the scene. A current image (4) of the scene is formed together with a present weighted reference image (6) which is formed from a plurality of previous images (8) of the scene. Cell data is established based on the current image (4) and the present weighted reference image (6). The cell data is statistically analysed so as to be able to identify at least one difference corresponding to a significant change of scene. When identified, an indication of such significant change of scene is provided.

The present invention relates to a method of detecting a significant change of scene occurring in a gradually changing scene, such as in video surveillance applications.

Methods are known in which one or more video cameras is or are used to provide surveillance of a scene in order to give warning of new or moving objects, such as intruders, in the scene. In one known method, changes in a scene are determined by point-by-point subtraction of a current video picture from a previous video picture. There are many problems associated with known techniques for image analysis. Of importance, the quantity of data that must be stored to continuously analyse changes on a point-by-point basis is relatively large. In addition, changes in illumination, such as formation or slow movement of shadows, changing light conditions, and ripples on water such as in swimming pools, are detected as changes in the scene in addition to changes resulting from significant new or moving objects, such as intruders, in the scene. Such a prior art arrangement cannot distinguish between slowly and rapidly occurring changes and can result in false alarms being provided.

It is an object of the present invention to overcome or minimise these problems.

According to the present invention there is provided a method of detecting a significant change of scene in a gradually changing scene, the method comprising: providing at least one camera means for capturing digital images of the scene; forming a current image of the scene; forming a present weighted reference image from a plurality of previous images of the scene; forming cell data based on the current image and the present weighted reference image; effecting statistical analysis of the cell data whereby at least one difference corresponding to a significant change of scene is identifiable; and providing an indication of such significant change of scene.

In an embodiment of the invention, the forming of the cell data and statistical analysis thereof may comprise the following steps:

forming a difference image representing the difference between the current image and the present weighted reference image; dividing the difference image into a defined number of cells dimensioned such that each cell is more than one pixel; calculating at least one of mean and variance values of pixel intensity within each cell;

forming the value of weighted reference cells based on the at least one of the mean and variance values from a plurality of previous reference cells, such weighted reference cells providing dynamically adaptive values for tracking slowly moving difference cells of the difference image; processing the dynamically adaptive values to form at least one of mean and variance values thereof;

and identifying any difference cell of the difference image having the at least one of the mean and variance values of pixel intensity exceeding the corresponding at least one of the mean and variance values of trigger threshold values, to indicate a significant change of scene.

The difference image may be formed by subtracting one of the current image and the present weighted reference image from the other of the current image and the present weighted reference image.

The processing of the dynamically adaptive values to form the at least one of the mean and variance values thereof may comprise multiplying the dynamically adaptive values by at least one scaling multiplier to form at least one of mean and variance trigger threshold values for each cell. Exceeding of any such at least one mean and variance trigger threshold value by a corresponding at least one mean and variance value of a difference cell of the difference image may result in such a cell being identified to indicate a significant change of scene.

Identification of a difference cell to indicate a significant change of scene may be effected by marking an equivalent cell in a computed image.

In a modification of the method of the invention, instead of forming the difference image directly as the difference between the current image and the present weighted reference image, both images are first divided into a predetermined number of equivalent cells dimensioned such that each cell is more than one pixel, the cells of both images being statistically analysed separately, followed by subtraction of the statistics of one of the current image and the present weighted reference image from those of the other of the current image and the present weighted reference image.

The present weighted reference image derived from the plurality of previous reference images may be such that equivalent pixels in each previous image have been allocated a weighted scaling towards the present weighted reference image.

Pixel intensity values in the present weighted reference image may be derived on the basis of a weighting factor determined by a digital filter time constant, which may have an inherent exponential form.

Modification (that is, increasing or decreasing) of the digital filter time constant may be effected such as to modify (that is, respectively slow down or speed up) exponential rise or decay of the present weighted reference image.

An increase in the digital filter time constant may result in an increase in the number of previous reference images which contribute to the present weighted reference image and an increase in a monitored previous time period.

A more recent previous weighted reference image may be arranged to contribute more value to the present weighted reference image than older previous weighted reference images.

A warning means may be activated when a significant change of scene is detected and indicated.

As a result of the method of the present invention and its use of a weighted reference image which adapts to gradual (i.e., slow-moving) changes in scene conditions, such gradual changes are incorporated into the reference image prior to comparison with the current image and are not detected nor indicated as new or moving objects. This means that changes in illumination of the scene, or shadows forming in the scene, or ripples forming on water, will not be identified as significant changes of scene, as opposed to relatively fast-moving objects in the scene, such as intruders.

The method of the present invention can also be used to detect stationary objects and/or intruders that have suddenly appeared in the scene or objects and/or intruders that have been moving and become stationary.

For a better understanding of the present invention and to show more clearly how it may be carried into effect, reference will now be made, by way of example, to the accompanying drawings in which:

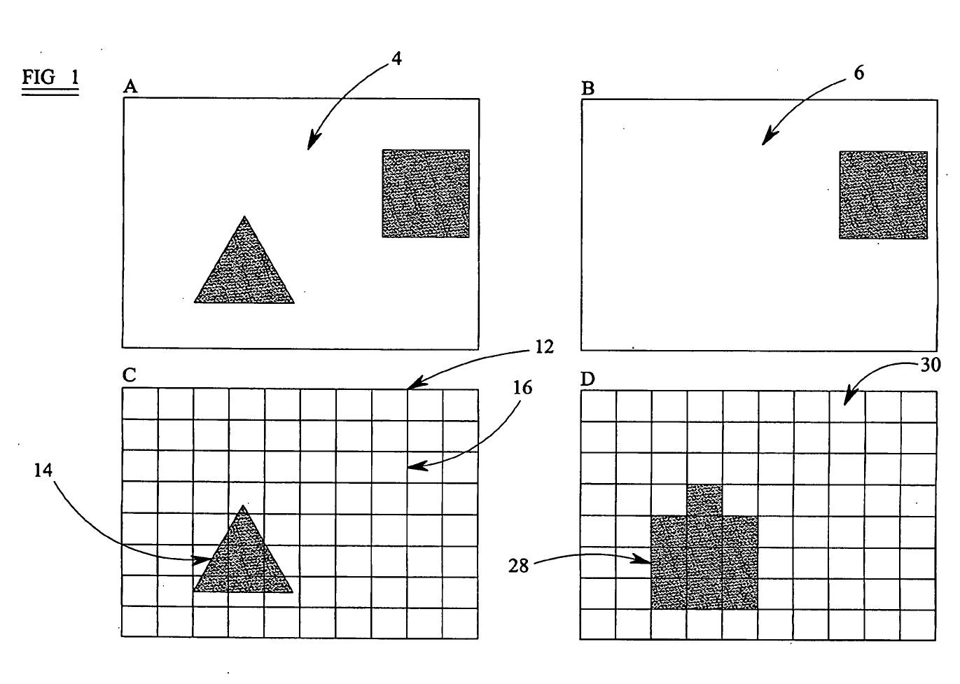

FIG. 1 is a representation of images formed in the method of the present invention;

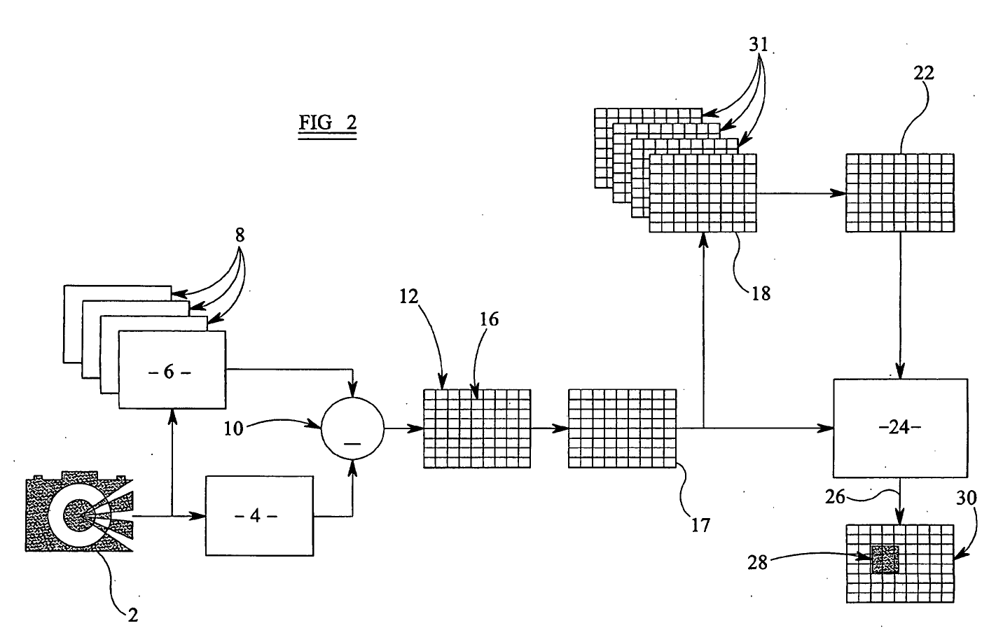

FIG. 2 is a flow diagram illustrating the method of the present invention; and

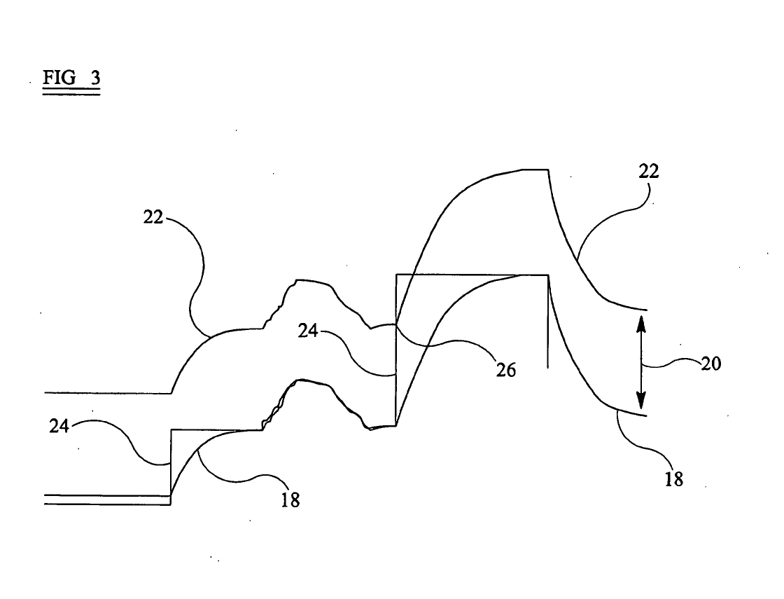

FIG. 3 is a graphical representation of an example of a scene change resulting in a mean value of pixel intensity for a given cell of a difference image exceeding a mean trigger threshold.

As shown in FIG. 2, one or more video cameras 2 is or are arranged for surveillance of an area under observation and for providing digital images of a scene in the area under observation. The camera or cameras 2 form(s) part of a system for tracking intruders or moving objects across the scene, such that when they enter or leave a designated area, such as a pool or other high security area, an alarm will be activated.

The system enables significant changes within the scene to be detected by discriminating between slow-moving environmental scene changes, such as shadows, and relatively fast-moving objects, such as people or animals who may be walking or running, or static objects being shifted into or away from the scene.

As will now be described, the method of the present invention involves four main stages.

In a first stage, as shown in FIGS. 1A and 2, a current image 4 of the scene is derived in digital video form. Also, as shown in FIG. 1B a weighted reference image 6, referred to herein as a present weighted reference image, is derived in digital video form. The present weighted reference image 6 is derived from a plurality of previous reference images 8 of the scene, with equivalent pixels in each previous image 8 having been allocated a weighted scaling towards the overall present weighted reference image 6. A weighting factor, used in deriving pixel intensity values in the present weighted reference image 6, is determined by a digital filter time constant which suitably takes on an inherent exponential form, although other mathematical forms could be considered.

The most recent weighted reference image is arranged to contribute the most value to the present weighted reference image, older weighted reference images contributing lesser value. The digital filter time constant can be increased or decreased to slow down or speed up the exponential rise or decay of the weighted reference image. The bigger the value of the digital filter time constant, the more previous images contribute to the present weighted reference image, resulting in an increase in a monitored previous time period. A reduction in the digital filter time constant will result in fewer images making up the present weighted reference image and will increase the probability of slower changes in the scene being detected as significant.

Each new present weighted reference image 6 is formed on a pixel-by-pixel basis by multiplying the intensity of each pixel of the previous weighted reference image by the digital filter time constant, which may, for example, have a value of 0.9. The equivalent pixel of the current image 4 is multiplied by a smaller number which is equal to 1 minus the digital filter time constant. In the present example this smaller number is 0.1 (i.e., 1 minus 0.9). The two resulting derived values are then added together to form the pixel intensity value for the new present weighted reference image. This process is carried out for each pixel to form a complete new present weighted reference image which is then used for the next cycle of reference image updating. For example, if the image has 100×100 pixels, there will be 10,000 digital filters working in real time to form the present weighted reference image. The exponential weighting function is inherent in the digital filter where previous weighted reference images have less significance the older they are. In the given example, the relative contribution of the previous weighted reference image is 0.9. The relative contribution of the next previous weighted reference image is 0.9×0.9, and so on until the older images have little or no contribution to the present weighted reference image. This works to advantage because there is greater interest in more recent events than in earlier events. In order for new objects in a scene to be incorporated into the present weighted reference image, they would need to be immobile for a period of time dependant on the time constant of the digital filter.

It is only required to store in memory the single previous derived weighted reference image, there being no need to store multiple previous images. If, for example, a straight averaging technique of, say, fifty images was used, there would be a need to store the previous fifty images so that all of the intensities could be added up on a pixel-by-pixel basis, and divided by the number of images. In this case it is likely that all of the previous images would have an equal weighting function. Such a technique would be expensive as a large amount of storage memory would be required.

In a second stage of the method of the present invention, the present weighted reference image 6 is used to evaluate what has changed in a current scene.

With the described digital filter technique, the present weighted reference image 6 is stored and the current image 4 is subtracted therefrom, as denoted by reference numeral 10, on a pixel-by-pixel basis, to form a difference image 12 indicating what has changed in the scene being monitored. The difference image 12 is shown in particular in FIG. 1C and only contains changes resulting from an object 14 with relatively fast movement, such as a moving person or object. It does not contain changes resulting from relatively slow movements, such as from moving shadows. If a person walks into the current scene, such person is seen on a neutral background in the difference image 12. The moving person or object 14 is seen as a solid image, rather than an outline as used by some other systems.

The pixel intensity in the difference image 12 can be either positive or negative in value. Although the absolute value can be used, additional information is available by looking at the positive and negative values. For example, shadows cast by a moving person or object tend to be darker than the background scene and therefore produc a known pixel intensity sign, which is positive or negative depending on whether the current image 4 was subtracted from the present weighted reference image 6, or vice versa.

One of the traditional ways of looking for movement in scenes is to look at individual pixel changes. This is susceptible to noise and is generally unreliable. Another technique is to look for pre-defined shapes, which generally uses edge detection and compares the outline with a standard model; i.e., a people model would look for tubular arms and legs and circular heads. A car model would look for car shapes. This method is very processor-intensive and assumes prior knowledge of what kinds of objects enter the scene. The system used in the method of the present invention is more generic and looks for all moving shapes.

The method works on colour images, using R G B (red, green, blue) or hue, saturation and luminance. It also works equally well with black and white images using intensity (brightness) or infrared. With colour images the information would be trebled and changes in individual colour components would be examined. However, the process would be the same. The method also works equally well in analysing images from scenes of media other than air, for example underwater, fluid-filled containers, gas-filled containers and the like.

In a third stage of the method of the present invention, the difference image 12 is divided into a defined number of cells 16 of any shape or size, where each cell is more than one pixel. As shown, all the cells 16 are of the same shape and size. However, they may be varied in different circumstances. Within each cell it is required to detect a scene change. If nothing has changed between the present weighted reference image 6 and the current image 4, all the pixel intensities in the difference image 12 will be zero, or very near zero. For example, in an 8×8 pixel cell there will be 64 pixel values of zero or very near zero. If there has been a significant change within that equivalent cell in the current image 4, then there will be higher (positive) or lower (negative) difference in pixel values in the difference image 12.

The mean and variance values 17 of all the pixel intensities within that cell are then derived. They each give information of a different sort. For example, if an arm moves to occupy half the pixels of the cell in question, then half the pixels will remain zero or very near zero and the other half may have positive intensity values. This will produce a change in the mean intensity value due to the increased positive value, and the variance in pixel intensity value over the cell will give a measure of the range of intensities within the cell. In this case, both the mean and variance values of intensity will change. However, if the arm fills the cell, with changed but equal pixel intensity values, then the mean value of intensity will change but the variance will remain at zero. Alternatively, there could be sequential changes within a cell, where the mean intensity value over time remains the same despite the intensity having varied, and here the variance would change. Thus, the system works best using both mean and variance but could equally work using just the mean or variance values.

In a fourth stage of the method of the present invention, attention is directed to the problem that the mean and variance of intensity will always have noise values associated with them, partly due to slow movements in the current image 4, and so will vary slightly in amplitude. This noise has to be accounted for when evaluating cells. This is achieved by using dynamically adaptive values and a scaling multiplier to give a trigger threshold, one for the mean of intensity, the other for the variance of intensity, and which tune themselves to follow the difference values of the mean and variance for each cell. Such dynamically adaptive values are provided by previous weighted reference cells 31.

The process is the same as for deriving the present weighted reference image 6 (digital filtering on a pixel-by-pixel basis) but digital filtering is now carried out for each statistic for each cell. Hence the intensity values of present weighted reference cells 18 are derived from a number of previous equivalent cells 31, where each equivalent cell in each previous image has been given a relative value towards that of the overall present weighted reference cell 18. As before, the weighting factor is determined by the digital filter time constant that takes on an inherent exponential form (but could take on other mathematical forms). The most recent cells contribute the most value, and the older cells a lesser value. This is effectively digital filtering on a cell-by-cell basis (for mean and variance), where the pre-defined digital filter time constant determines the number of previous cells making up the present weighted reference cells. The effect of increasing or decreasing the digital filter time constant is to slow down or speed up the exponential rise or decay of the present weighted reference cell 18. The bigger the digital filter time constant, then the more previous cells 31 contribute to the new present weighted reference cell 18, so that the time period monitored is increased. The effect of having fewer previous cells 31 making up the present weighted reference cells 18 (shorter time constant in the digital filter) will increase the probability of slower changes in intensity appearing in the final computed present weighted reference cells 18.

The values of the mean and variance intensity for each present weighted reference cell 18 provide the dynamically adaptive values. The dynamically adaptive values are multiplied by a scaling multiplier 20 to provide mean and variance trigger thresholds 22 of pixel intensity for each reference cell 18 and, as shown in FIG. 3, provide a margin of error when determining scene changes.

Exceeding of any such mean and/or variance trigger threshold 22 by a mean and/or variance value 24 of a difference cell 16 of the difference image 12 results in a significant scene change event 26 being identified and the equivalent cell 28 is marked in a computed image 30 as shown in FIG. 1D.

A warning means (not shown) can be arranged to be activated when such a significant scene change is identified.

The following is given by way of example. One of the difference cells is pointed to a calm water surface and has a mean value of 5 (consider just the mean for now). The equivalent present weighted reference cell 18 also has a value of 5 and has been stable for some time. If the scaling multiplier had a value of 2, then the mean trigger threshold would be set at 10. Consider if the wind picks up, the water starts to ripple and the mean intensity for the difference cell increases to 8. This would not exceed the trigger threshold, so there would be no scene change noted in that cell. Slowly the equivalent present weighted reference cell value for mean intensity increases exponentially to 8 (so the trigger threshold changes to 8×2=16). The time taken to catch the difference cell up will depend on the digital filter time constant. Consider then a person falls into the water. A large sudden change occurs in the scene, and the mean intensity for the difference cell increases to 60. As the mean intensity for the difference cell now exceeds the trigger threshold for the equivalent present weighted reference cell 18, then the equivalent cell in the computed image is marked. An alert is generated and action can then be taken as a result of the marked cells in the computed image if required. This same technique also applies for the variance intensity.

It should be noted that specified areas of the scene could have different digital filter time constants and threshold constants applied to them. For example, an area of water within the scene may require different values due to the water movement.

An important aspect of the method of the present invention is the statistical analysis of the cells to detect scene change.

In a modification of the method of the invention, instead of subtracting the current image 4 from the present weighted reference image 6, both the current image 4 and the present weighted reference image 6 are divided into a predetermined number of equivalent cells dimensioned such that each cell is more than one pixel, and both images are statistically analysed separately, followed by subtraction of the statistics of the current image from those of the present weighted reference image, or vice-versa.

The following aspects of the invention can be varied or altered while accomplishing the same end result:

1. Image size

2. Frame rate (i.e. the rate at which the current image is updated)

3. The technique can be applied to any image, regardless of its origin, for example colour (red, green and blue), greyscale (black and white), infrared or any other image originating from the electromagnetic spectrum

4. The number of previous images used to generate the present weighted reference image, determined by the digital filter time constant.

5. The size and shape of the individual cells used to divide the images for analysis. Hence, cells may be of regular or irregular shape and adjacent cells may be of different size and shape.

6. Use of different statistics or analysis on the pixel intensities within each cell, e.g. mean, variance, standard deviation, skewness, kurtosis and the like.

7. The number of previous images used to generate the present weighted reference cells, determined by the digital filter time constant.

8. The scaling multiplier used to offset the dynamic adaptive value.

1. A method of detecting a significant change of scene in a gradually changing scene, the method comprising: providing at least one camera means (2) for capturing digital images of the scene; forming a current image (4) of the scene; forming a present weighted reference image (6) from a plurality of previous images (8) of the scene; forming cell data based on the current image (4) and the present weighted reference image (6); effecting statistical analysis of the cell data whereby at least one difference corresponding to a significant change of scene is identifiable; and providing an indication of such significant change of scene.

2. A method according to claim 1, characterised in that the forming of the cell data and statistical analysis thereof is characterised by the following steps: forming a difference image (12) representing the difference between the current image (4) and the present weighted reference image (6); dividing the difference image into a defined number of cells (16) dimensioned such that each cell is more than one pixel; calculating at least one of mean and variance values (24) of pixel intensity within each cell; forming the value of weighted reference cells (31) based on the at least one of the mean and variance values from a plurality of previous reference cells, such weighted reference cells providing dynamically adaptive values for tracking slowly moving difference cells of the difference image (12); processing the dynamically adaptive values to form at least one of mean and variance values thereof; and identifying any difference cell (16) of the difference image (12) having the at least one of the mean and variance values of pixel intensity exceeding the corresponding at least one of the mean and variance values of trigger threshold values (22), to indicate a significant change of scene.

3. A method according to claim 2, characterised in that the difference image (12) is formed by subtracting one of the current image (4) and the present weighted reference image (6) from the other of the current image and the present weighted reference image.

4. A method according to claim 2 or 3, characterised in that the processing of the dynamically adaptive values to form the at least one of the mean and variance values thereof comprises multiplying the dynamically adaptive values by at least one scaling multiplier (20) to form at least one of mean and variance trigger threshold values (22) for each cell.

5. A method according to claim 4, characterised in that exceeding of any such at least one mean and variance trigger threshold value (22) by a corresponding at least one mean and variance value of a difference cell (24) of the difference image (12) results in such a cell being identified to indicate a significant change of scene.

6. A method according to any one of claims 2 to 5, characterised in that identification of a difference cell to indicate a significant change of scene is effected by marking an equivalent cell in a computed image (30).

7. A method according to claim 2, characterised in that the current image (4) and the present weighted reference image (6) are first divided into a predetermined number of equivalent cells dimensioned such that each cell is more than one pixel, the cells of both images being statistically analysed separately, followed by subtraction of the statistics of one of the current image (4) and the present weighted reference image (6) from those of the other of the current image and the present weighted reference image.

8. A method according to any preceding claim, characterised in that the present weighted reference image (6) derived from the plurality of previous reference images (8) is such that equivalent pixels in each previous image have been allocated a weighted scaling towards the present weighted reference image.

9. A method according to claim 8, characterised in that pixel intensity values in the present weighted reference image (6) may be derived on the basis of a weighting factor determined by a digital filter time constant.

10. A method according to claim 9, characterised in that the digital filter time constant has an inherent exponential form.

11. A method according to claim 9 or 10, characterised in that modification of the digital filter time constant is effected such as to modify the exponential rise or decay of the present weighted reference image (6).

12. A method according to claim 9, 10 or 11, characterised in that an increase in the digital filter time constant results in an increase in the number of previous reference images (8) which contribute to the present weighted reference image (6) and an increase in a monitored previous time period.

13. A method according to any preceding claim, characterised in that a more recent previous reference image (8) is arranged to contribute more value to the present weighted reference image (6) than older previous reference images (8).

14. A method according to any preceding claim, characterised in that a warning means is activated when a significant change of scene is detected and indicated.
